(19) United States
(12) Patent Application Publication
(10) Pub. No.: US 2026/0346736 A1
(43) Pub. Date: Nov. 5, 2026

(54) MODULAR CONTROLLER FOR ELECTRIC VEHICLES

(71) Applicant: Sona BLW Precision Forgings Limted, Gurgaon (IN)

(72) Inventors: Suresh V, Range-Chengalpattu (IN); Dharma Senthil K, Range-Chengalpattu (IN); Sureshkumar B, Range-Chengalpattu (IN); Somou Suresh N, Range-Chengalpattu (IN); Muruganandam RADHAKRISHNAN, Range-Chengalpattu (IN); Praveen CHAKRAPANI RAO, Range-Chengalpattu (IN)

(21) Appl. No.: 19/487,280

(22) PCT Filed: May 22, 2024
(86) PCT No.: PCT/IN2024/050596

§ 371 Date: Nov. 24, 2025

(30) Foreign Application Priority Data
May 22, 2023 (IN) 202311035544

(51) Int. Cl. B60L 15/34; B60L 3/00; B60L 15/20

(52) U.S. Cl. CPC B60L 15/34; B60L 3/0084; B60L 15/20; B60L 2240/421; B60L 2240/423; B60L 2240/525; B60L 2250/26

(57) ABSTRACT

The present invention discloses a system (100) for a modular controller for an electric vehicle wherein a plurality of add-on controller modules (20) is electrically coupled with the master or modular controller module (10) to meet a high power and torque requirement without changing the whole controller. The plurality of add-on controllers (20) is integrated with the master controller module (10) using connecting means like busbar (50) or any material with conductivity etc., but not limited to it. Furthermore, the master controller will control the add-on controller via a signal interface connector (30) and a second signal interface connector will get input from electric vehicle. The present invention enables stacking multiple add-on controllers (20) externally with a master controller module, making integration quick and easy, user-friendly and cost-effective.

### FIELD OF THE INVENTION

The present invention generally relates to the field of modular controller utilized in electric vehicles. More particularly, it relates to the incorporating of one or more add-on controllers on an existing master controller for the optimization of torque and speed of electric vehicles without changing the master controller, internally. A method of operation for the same has been disclosed thereof.

### BACKGROUND

A modular controller is a device that controls the operation of an electric motor. It regulates the amount of power sent to the motor, and controls the speed and torque of the vehicle. It also monitors the vehicle's systems and provides feedback to the driver. The controller is responsible for controlling the power from the battery to the electric motor, and it also provides a way to regulate the motor's speed.

A modular inverter is a device that converts direct current (DC) power from the battery into alternating current (AC) power, which is then used to drive the electric motor. It is a separate component in the powertrain of an electric vehicle.

Both the modular controller and the modular inverter work together to provide power to the electric vehicle and control its operation. In the existing prior art, modular controller and inverter are used for standalone applications.

For example, U.S. Pat. No. 10,850,623 assigned to Chongqing Jinkang Powertrain New Energy Co Ltd entitled “Stacked electric vehicle inverter cells” deals with systems and methods of providing an inverter module which can be incorporated into a power converter component to power a drive unit of an electric vehicle drive system. The inverter module includes multiple inverter cells electrically coupled with each other and arranged in various stacked configurations for different electric vehicle drive systems. The various stacked configurations provide continuous channels for coolant flow to transfer heat generated in the inverter cells away from the inverter cells. The inverter module can be coupled with a drive train unit of the electric vehicle and can be configured to provide multi-phase voltages to the drive train unit.

In the existing stacking arrangements of a controller/inverter, it is necessary to add the stacking inverter/add-on controller internally every time when there is a necessity to open the controller and fix the add-ons and again close with screws and other materials.

To overcome the aforementioned limitations, the present invention proposes a plurality of add-on controllers electrically coupled/connected externally to the existing modular controllers of an electric vehicle. The externally stacked add-on controllers can be easily integrated and are user-friendly and cost-effective.

Even though stacking of controllers or inverters are already available in heavy industries and its products, it is not implemented in moving vehicles as stacking of controllers or inverters consumes more space. Particularly, when stacking of controllers is installed in moving vehicles it provides sufficient power such as 2 kw or 4 kw or 10 kw for motor.

Furthermore, in case the power requirement of motor is increased to 4 kW, in prior art it is necessary to change the whole module with new controller (which will be bulk and have different shape and not adaptable to available space within the vehicle) having capability of 4 kw since the main controller of prior art can provide only 2 kW power to the motor. This process is not cost effective and also it is difficult to adapt within the space available in the existing vehicle.

The present invention overcomes the aforementioned limitations and proposes a main controller which has the ability to handle highest 10 kw power transfer to motor with the help of other add-on controllers, and the controller module can perform both controller function and inverter function.

### OBJECTIVES OF THE INVENTION

The primary objective of the present invention is to configure a modular controller wherein a plurality of add-on controllers is incorporated/integrated with an existing master controller in a stacked-up manner for upgrading power and torque requirements.

Another objective of the present invention is to configure an upgraded modular controller to meet the higher power and torque requirements of electric vehicles.

Yet another objective of the present invention is wherein the interfacing of the master controller with the add-on controllers are done externally and without an internal change in the main controller module.

Yet another r objective of the present invention is wherein the incorporating/integrating of the master controller to the add-on controllers are done employing suitable connectors.

Another objective of the present invention is to configure a modular controller wherein a quick, easy and user-friendly integration of the add-on controllers is facilitated while maintaining cost-effectiveness.

### SUMMARY

The following summary is provided to facilitate a clear understanding of the new features in the disclosed embodiment, and it is not intended to be a full, detailed description. A detailed description of all the aspects of the disclosed invention can be understood by reviewing the full specification, the drawing, and the claims and the abstract, as a whole.

In order to achieve the aforementioned objectives, an aspect of the present invention discloses a system and a method for an electric vehicle controller system. The system comprises integration/incorporation of a plurality of add-on controllers onto a master controller of an electric vehicle by stacking them to meet the power and torque requirements in electric vehicles. The main objective of this application is to meet the requirements of automotive drive motor applications without changing the main controller module.

According to a further aspect of the present invention, it is disclosed that multiple add-on controllers are integrated/interfaced/incorporated to the master controller utilizing any suitable interface connectors like cable connectors, common busbar etc., but not limited to it. The add-on controllers are connected externally to the existing main or master controller module without disturbing the same, to obtain a modular controller for application in electric vehicles. Simple screws or other fasteners are used to link the main controller module with the add-on controllers via bus bar or other connecting means. Furthermore, the multiple add-on controllers employ signal interface connectors to establish an electrical connection with the gate drivers between the add-on controllers.

Another aspect of the present invention, discloses that the modular controller, which is a combination of the master controller and the add-on controller, comprises a wiring harness through which the master controller is incorporated with the add-on controllers, and controls the electric motor. The multiple add-on controllers integrated with the master controller upgrades the torque and speed rating for the electric vehicle, depending on user requirements.

Yet another aspect of the present invention discloses that each add-on controller comprises provisions for temperature measurement for protection from high temperatures.

Thus, the present invention enables stacking/interfacing/incorporating multiple add-on controllers externally with existing master or modular controller, making integration quick and easy, user-friendly and cost-effective.

A further aspect of the present invention discloses a method of operation for the electric vehicle controller system, characterized by modular components for optimal efficiency. The master controller assumes a dual role, efficiently managing both control logic and the power board, forming the core of the system with essential functionalities for torque and speed control. Complementing this, the add-on controller specializes in interfacing with the power board, integrated into the master controller, thereby, facilitating system expansion and customization based on specific performance requirements. Seamless communication between controllers is achieved through an interface, such as bus bar, ensuring efficient power distribution and creating a cohesive system. Additionally, the signal interface connector plays a pivotal role by providing a dedicated interface for the gate driver in the add-on controller, enhancing communication and ensuring precise control over the electric motor. This method integrates modularity and strategic interfaces, offering flexibility and heightened performance in electric vehicle control.

In summary, the modular electric vehicle controller system, with its Master Controller, Add-on Controller, Bus Bar, and Signal Interface Connector, offers a flexible and scalable solution for achieving optimal control and power distribution in electric vehicle.

### BRIEF DESCRIPTION OF THE DRAWINGS

The present invention will be better understood fully from the detailed description that is given herein below with reference to the accompanying drawings of the preferred embodiments of the present invention, which, however, should not be deemed to be a limitation to the invention to the specific embodiments, but, are for the purpose of explanation and understanding only.

FIG. 1 illustrates the standalone structure of master module and add-on module.

FIG. 2 illustrates the overall schematic of modular controller obtained by combining master module and add-on module.

FIG. 3(a), 3(b) shows the multiple add-on modules and its connection mechanism with each other.

FIG. 4 shows the add-on module connection with busbar according to one embodiment of the present invention.

### LIST OF REFERENCES

100—modular control system
10—master controller module
20—add-on controller module
30—signal interface connector
40—studs
50—busbar

### DETAILED DESCRIPTION OF THE INVENTION

The following is a description of the present disclosure depicted in the accompanying drawings. However, it may be understood by a person having ordinary skill in the art that the present subject matter may be practised without these specific details. In other instances, well-known methods, procedures, and/or components regarding the said method have not been described in detail so as not to obscure the subject matter of the disclosure. The subject matter of the disclosure will be more clearly understood from the following description of the embodiments thereof, given by way of example only with reference to the accompanying drawings, which are not drawn to scale.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

The present invention discloses a modular control system wherein a plurality of add-on controllers are stacked or added-on in various configurations to a master controller in an electric vehicle. The purpose is to fulfil the high power and torque requirements of electric vehicles particularly in applications such as automotive drive motors all without requiring alterations to the main controller.

“Bus bar” refers to a conductive metal strip or bar used to distribute electrical power within an electrical system. It serves as a common electrical connection point for multiple circuits and provides a path for the flow of electrical current. A “signal interface” is a point of communication between different components of an electronic system, allowing them to exchange data and control signals. Signal interfaces are essential for coordinating actions, sharing data, and achieving synchronized operation.

The terms “master module”, “control module” and “master controller module” are used interchangeably here. Similarly, the terms “add-on module”, and “add-on controller” are used interchangeably here. Additionally, the terms “modular control system”, “modular system”, “modular controllers”, and “modular inverter” is used interchangeably here.

Stackable inverters are already available in industrial products. However, the present invention provides stackable modular controllers used in moving vehicles. When the inverters are stationary and stackable it will not raise any new issues or complaints. However, when installed in a moving vehicle, problems such as space constraints, boundary constraints arise especially, when new stacks introduced.

The present invention provides a solution of limited upgrade without introducing new separate control modules. According to the present application, control module that will adapt with master controller module are integrated with the same. Moreover, the configurations of the stacked modules are based on requirements of the electric vehicle which can range between 2 kilowatt or 4 kilowatts, to up to 10 kilowatt. By this configuration space constraint is solved. When the new control module is easily adapted to the old existing module in the vehicle then boundary constraints will be solved, too. Here, control modules are meant to be controllers.

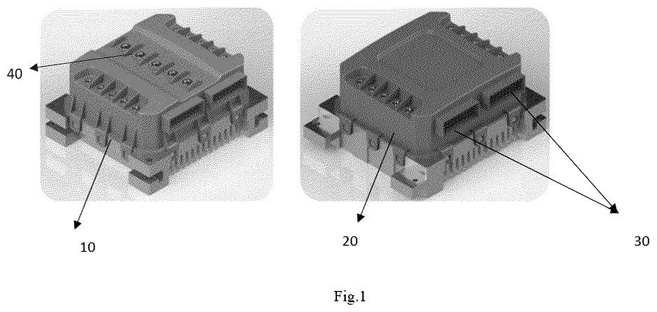

FIG. 1 illustrates a standalone representation of a master controller module (10) and an add-on controller module (20) for the purposes of the present invention in an electric vehicle. According to FIG. 1, the master controller module (10), designed for a 2-kilowatt power capacity, serves as the central control unit in the electric vehicle system, orchestrating essential functions for optimal performance. Furthermore, the add-on controller module (20) referred to in FIG. 1 is designed for a 2-kilowatt power capacity for upgrading the functionalities of the master controller module (10).

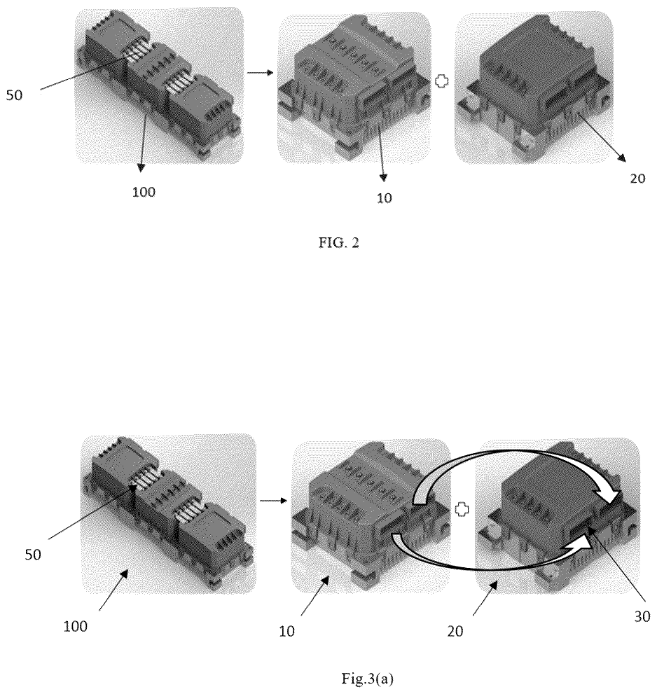

FIG. 2 illustrates a modular controller/modular inverter (100) that is obtained by combining the master controller module (10) and the add-on controller module (20) referred to FIG. 1. According to present invention and referring to FIG. 2, the modular controller (100) performs both controller and inverter functions. When a new add-on controller (20) is stacked, the software of the existing control module gets updated for 2 kw or 4 kw accordingly and the required power gets synchronized automatically.

Therefore, the master controller (10) regulates the add-on controller (20) for efficient power management in an electric vehicle. Referring to FIG. 2, it is observed that the master controller (10) is interfaced with two signal connectors (30)_, one to receive input from the electric vehicle's throttle, and the other to control the add-on controller (20). The throttle input is crucial as it directly influences the motor speed and RPM (revolutions per minute), ensuring responsive and adaptive control of the said vehicle.

Furthermore, the master controller (10) is composed of two distinct printed circuit boards (PCBs) (not shown here): a power PCB and a control PCB. This dual-PCB configuration segregates the power management functions from the control logic, enhancing reliability and performance. The add-on controller (20), in contrast, is simplified with a single power PCB, as it primarily functions to augment the master controller's power output when needed.

Coming back to FIG. 2, there are five studs (40) located in the middle of the housing of the master controller (10). These studs (40) serve as critical connection points, wherein three are designated for the RYB (red, yellow, blue) phase terminals to connect to the motor, and two for the battery positive and negative terminals, of the battery This setup facilitates the direct transfer of power from the battery to the motor through the master controller (10).

Referring back to FIG. 2, it is noted that the master controller module (10) can provide only 2-kilowatt power to the motor. When the motor power demand exceeds 2 kW, the add-on controller steps in to share the load. The add-on controller (20) transfers additional power to the master controller (10) via a busbar (50) or equivalent conductive connection.

Consequently, the master controller (10) channels this supplementary power to the motor, ensuring seamless power delivery and optimal performance.

Moreover, the master controller (10) includes ten additional studs (not shown) distributed on the left and right sides for power transfer between two add-on controllers. This design feature allows for scalable power management, accommodating varying power requirements by dynamically balancing the load between the master and add-on controllers.

With the addition of the add-on controllers (20), the master controller (10) gets the ability to handle a power transfer of at least 10-kilowatt to the motor of the electric vehicle. Traditional approaches necessitated the replacement of the entire module with a new controller in the event the power requirement of the motor is elevated to only 4 kilowatts. This replacement is often cumbersome, involving a bulkier design with a different shape, and poses challenges in adapting to the available space within the vehicle.

The signal interface connectors (30) play a pivotal role in this system. A first signal interface connector receives data such as speed and RPM from the throttle, which the control PCB uses to modulate motor performance. A second signal interface connector enables the master controller (10) to govern the add-on controller (20) using a PWM (Pulse Width Modulation) signal. This bidirectional communication ensures precise and coordinated control over the power distribution.

Referring back to FIG. 2, the connection between the master and add-on controllers (10, 20) through the busbar (50) can be established using any conductive material, such as bus wires. This flexibility in connection methods ensures robust and reliable power sharing, adaptable to various design constraints and installation environments.

Therefore, as depicted in FIG. 2, it is evident that an additional add-on controller (20) or a slave controller, maintaining the same size and shape as the existing master controller (10), can be incorporated with a 2-kilowatt capacity, to the master controller. This integration effectively increases the total output to the electric motor, achieving a 4-kilowatt power capacity. Should there be an upgrade to a 10-kilowatt power for the electric motor, the feasibility exists to incorporate four add-on controllers (20) to the master controller module 10, thereby fulfilling the power requirements of the vehicle without the necessity of replacing the entire controller. Stated otherwise, when the master controller (10) is stacked with add-on controllers (20), the power output to the electric motor will be improved, and when the motor controller power increases, the output speed, range and torque of the vehicle will be enhanced.

For instance, a vehicle with a 2-kilowatt power configuration achieves an approximate speed of 45 kilometres per hour. Upon upgrading to a 4-kilowatt configuration, the vehicle is expected to attain a speed of at least 90 kilometres per hour, achieved through the straightforward addition of an add-on controller. Importantly, this upgrade occurs without any disruption to the existing frame of the vehicle.

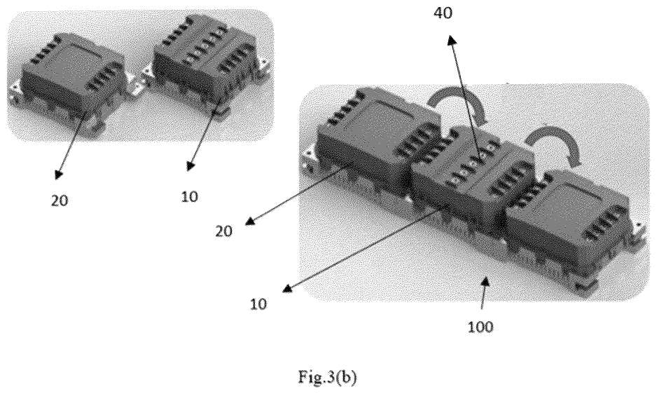

FIG. 3(a) further illustrates a master controller (10) and an add-on controller (20) connected to each other via busbars (50) or any other conductive material. FIG. 3(b) discloses multiple add-on controllers (20) connected to a master controller (10) according to the present invention. As depicted in FIGS. 3(a) and 3(b), the modular controller (100) in accordance with the present invention is a seamless combination of the master controller module (10) and multiple add-on controllers (20), representing a sophisticated approach to control systems.

Upgrading the modular controller (100) with an easy to integrate add-on controller (20) provides about 2-kilowatt power output to the electric vehicle. This way, a plurality of add-on controllers (20) can be linked with the master controller to provide a modular controller (100) to increase the power capacity of electric vehicles preferably up to 10 KW, but not limited to it.

The add-on controller module (20) can be utilized to adjust ratings based on specific user requirements by enhancing the capabilities of the system by linking with the master controller module (10), thus producing a customizable upgrade. According to FIGS. 3(a) and 3(b), the modular controller (100) thereby facilitates adaptability to diverse user needs but also streamlines the upgrading process, promoting efficiency and cost-effectiveness.

Referring back to FIGS. 2 and 3, the collaboration between the master controller (10) and add-on controller (20) modules embodies a modular approach, providing a versatile and flexible solution for applications where dynamic adjustments and expansions are required. This modular controller (100) design not only simplifies the initial setup with a standardized Master Controller but also empowers users to tailor their systems over time, aligning with evolving demands and technological advancements.

### Experimental Data

Table 1 shows a study, wherein a master controller is integrated with one, two and three add-on controllers according to the present invention. The master controller operates at 2 kW with a maximum speed capability of 700 RPM and a maximum torque of 40 Nm.

TABLE 1

| | | Max | | Total | | After Add-on |
|---|---|---|---|---|---|---|
| Master | Max | Torque | Add-on | Controller | After Add-on | Controller Max |
| Controller | Speed | @ RPM | Controller | Capacity | Controller Max | Torque @ RPM |
| (KW) | (RPM) | (Nm) | (KW) | (KW) | Speed (RPM) | (Nm) |
| 2 | 700 | 40 | 2 | 4 | 2000 | 55 |
| 2 | 700 | 40 | 2 + 2 | 6 | 5000 | 65 |
| 2 | 700 | 40 | 2 + 2 + 2 | 8 | 7000 | 75 |

It is therefore noted that when a plurality of add-on controllers (20) is connected to the master controller (10), the maximum speed capability and the maximum torque capacity of the modular controller (100) increases, significantly.

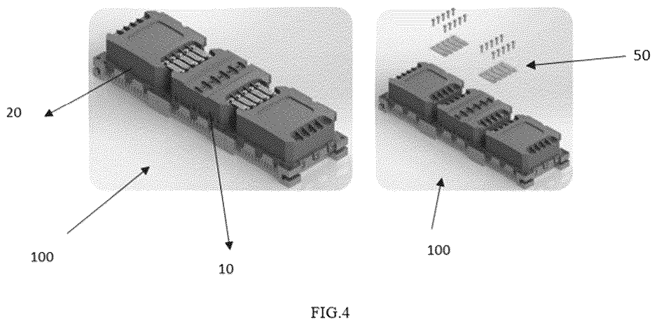

FIG. 4 illustrates the stacked-up add-on connection to the master controller module (10) in such a way that the modular controller (100) would provide higher outputs. Furthermore, it is illustrated that the add on controllers (20) having same physical structure of main controller can be added using simple busbar (50) or any other connecting means, as shown in FIG. 4.

On the other hand, if customer requires 2 kw then single master controller (10) is sufficient to provide the required power of 2 kw. If customer requires 4 kw then it is possible to add or stack another add-on controller (20) of 2 kw to the existing main controller which has ability to control and provide power of 10 kw motor with the help of add-on controllers. Not only that, the master controller (10) can have a power rating of 3 kW, 5 KW or even 10 kW.

Further, the master controller module (10) is the only module output connected to the vehicle motor input. The remaining add-ons work as a slave controller.

As illustrated in FIGS. 2-4, the integration of one or more add-on controllers (20) with the master controller module (10) is effortlessly achieved through various connectors, including cable connectors, sliding slots for controller linkage, busbars, and similar options, without being limited to these. In this embodiment of the present invention, FIG. 4 specifically demonstrates the connection of the add-on modules (20) via the busbar (50). In this configuration, the central controller functions as the master controller module (10), while the left and right controllers are add-on controller modules (20) connected through busbars (50) using screws/studs. In accordance with an embodiment of present invention, the add-on controller further comprises provisions for temperature measurement to protect from over temperature.

Therefore, the present invention facilitates the external stacking of multiple add-on controllers (20) onto the pre-existing modular or master controller (10). This eliminates the necessity for complex, time-consuming, and costly upgrades or changes to the master controller (10). This approach guarantees a seamless, uncomplicated, user-friendly, and cost-effective integration process.

A method of operation of the present invention is further disclosed wherein the modular controller system (100) of an electric vehicle is designed with modular components to ensure efficient and adaptable performance. The master controller module (10) serves a dual role capable of managing both the controls system and the power Board. This central component forms the core of the system and capable of managing both control system and power, essential functionalities for torque and speed control. This modular approach allows users to expand and customize the system based on specific performance requirements. Facilitating a seamless communication between the master controller (10) and add-on controller (20) modules is the bus bar (50) or any conductive material, that streamlines the integration process. The bus bar ensures efficient power distribution and communication between the controllers, creating a cohesive system. Additionally, the signal interfaces (30) enable receiving throttle data like speed and RPM for motor modulation, and allows the master controller (10) to manage/govern the add-on controller (20) via a PWM signal. Therefore, in the realm of electric vehicles, elevated ratings typically signify increased power and performance, encapsulating various critical aspects. The power rating, impacting acceleration and overall functionality, holds paramount importance, as higher ratings indicate superior capabilities. Torque rating is indispensable for effective acceleration and uphill driving. Addressing range anxiety, battery capacity influences driving range, while heightened charging speeds enhance daily practicality. Comprehensive performance metrics, encompassing top speed, efficiency, and handling, provide a holistic assessment of an electric vehicle's adaptability to diverse driving conditions. Essentially, higher ratings in electric vehicles denote a more potent, efficient, and capable electric vehicle, catering to those who prioritize enhanced performance or an extended range on a single charge.

We claim:

1. A modular controller system (100) for a motor of an electric vehicle comprising,
a master controller (10) comprising
a power printed circuit board (PCB) and a control printed circuit board (PCB);
a first signal interface connector (30) configured to receive an input throttle from a user;
a second signal interface connector (30) configured to communicate with at least one add-on controller;
a set of five studs (40) positioned in the middle of the housing of the master controller (10), comprising three phase terminals (red, yellow, blue) for motor output and two terminals for battery input (positive and negative); and
a set of ten additional studs positioned on lateral sides of the master controller (10) for power transfer between add-on controllers;
at least one add-on controller (20) comprising a power printed circuit board (PCB) and a connection interface to receive signals for power sharing instructions from the master controller (10); and
a busbar (50) or equivalent conductive external connection means is utilized for transfer of power between the master controller (10) and the at least one add-on controller (20), wherein the system provides an enhanced power output to the motor.

2. The system (100) as claimed in claim 1 wherein the master controller (10) distributes power to the motor, and when a power demand exceeds the said distributed power capacity of the motor controller, the master controller and the at least one add-on controller (20) share the power load via the busbar (50) or equivalent conductive connection.

3. The system (100) as claimed in claim 1, wherein the master controller controls the motor speed and revolutions per minute (RPM) based on the input received through the signal interface connectors (30).

4. The system (100) as claimed in claim 1, wherein the master controller (10) directs the add-on controller (20) to provide additional power when the motor power requirement exceeds the distributed power by the master controller (10).

5. The system (100) as claimed in claim 1, wherein a plurality of add-on controllers (20) are linked onto the master controller module (10) by external means such as busbars or equivalent conductive connection, and secured by fasteners.

6. The system (100) as claimed in claim 1, wherein the busbar (50) connection is established using bus wires or any other equivalent conductive material connection.

7. The system (100) as claimed in claim 1 wherein the at least one add-on controller (20) comprises a temperature measuring system configured for temperature protection.

8. The system (100) as claimed in claim 1, wherein the master controller (10) coordinates the overall operation of the motor and the at least one add-on controller (20) to optimize power efficiency and performance.

9. The system (100) as claimed in claim 1, wherein the system (100) is utilized in an electric vehicle.

10. A method for operating a modular controller system (100) for a motor, the method comprising steps of:
externally linking at least one add-on controller (20) to a master controller (10) via connection interfaces for external linking;
securing an electrical connection between the at least one add-on controller module (20) and the master controller module (10) via a busbar or equivalent conductive connection, secured by fasteners;
transferring interface signals between the at least one add-on controller (20) and the master controller (10) via a signal interface connector (30);
wherein power capacity output of the master controller is enhanced to a power output from the master controller (10) and the at least one add-on controller (20) to provide an enhanced power output.

11. The method as claimed in claim 10 wherein the power output of the modular controller system (100) is synchronized automatically and updated as per user requirement.

12. The system (100) as claimed in claim 1 wherein the system facilitates external linking between the master controller (10) and at least one add on controller (20) thereby excludes internal modification to the master controller (10).

13. The method as claimed in claim 11 wherein connecting the add-on controllers (20) to the master controller (10) by external linking excluding internal modification to the master controller (10).
